(19) United States
(12) Patent Application Publication
(10) Pub. No.: US 2026/0179200 A1
(43) Pub. Date: Jun. 25, 2026

(54) ENHANCING VIDEO CONTENT CAPTURED FOR VIDEO PASS-THROUGH

(71) Applicant: Adeia Guides Inc., San Jose, CA (US)

(72) Inventors: Tao Chen, Palo Alto, CA (US); Ning Xu, Irvine, CA (US)

(21) Appl. No.: 18/989,819

(22) Filed: Dec. 20, 2024

(51) Int. Cl. G06T 5/92; G06T 7/13; G06T 7/60; G06T 7/73; G06T 19/00; G06V 20/20

(52) U.S. Cl. CPC G06T 5/92; G06T 7/13; G06T 7/60; G06T 7/73; G06T 19/006; G06V 20/20; G06T 2207/10016; G06T 2207/20164; G06T 2207/20208

(57) ABSTRACT

Systems and methods for displaying a processed representation of media content on an extended reality (XR) device are disclosed herein. The XR device identifies a media device in its physical environment displaying media content and captures a pass-through video of the environment, including a representation of the media device showing the content. The representation is defined, in part, by a display parameter with a first value. The XR device establishes a wireless connection with the media device to receive data for displaying a representation of the content with a display parameter having a second value. Based on its display capabilities and the received data, the XR device processes the representation to adjust the display parameter to a second value, enhancing the content presentation. The processed representation is then displayed on the XR device, ensuring the media content aligns with the XR device's capabilities for an optimized user experience.

### BACKGROUND

The present disclosure is related to enhancing content in an extended reality (XR) environment.

### SUMMARY

Head-mounted displays (HMDs) with video pass-through use the HMD's front cameras to capture a live feed of the surrounding environment. The live feed is displayed on the device's near-eye display, and, in some instances, is combined with virtual objects to create a mixed reality (MR) or augmented reality (AR) video. As more MR- or AR-focused HMDs enter the market, they will need to be configured to provide virtual objects at a high quality while enabling efficient interactions with the surrounding environment. In particular, there is a need to enhance the presentation of video content, which is captured by the HMD via video pass-through while being displayed by external devices in the real-world environment—such as smartphones, televisions, and monitors—to help provide a seamless and high-quality experience that reduces lag, enhances visual clarity, and supports shared viewing.

In some approaches, the HMD displays video content from an external display device based on video data captured by cameras and sensors of the HMD. Modern HMDs are often equipped with superior display technologies capable of rendering high dynamic range (HDR) content. However, the HMD cameras and/or rendering processes may be unable to produce video quality that matches the advanced capabilities of the HMD, resulting in quality loss due to limited resolution, sensor noise, compression artifacts, and/or latency, for instance. Furthermore, the external display device may have limitations in display quality such as brightness, dynamic range, and/or color gamut in comparison to the display capabilities of the HMD display. For instance, a monitor screen may have a maximum brightness of 300 nits and support a standard dynamic range, whereas the display of an HMD may support as high as 4000 nits and support HDR tone mapping. This means HDR content may be rendered better or with higher quality on the HMD screen. Thus, rendering external videos based on HMD camera data is burdened by the combined capturing limitations of the HMD's cameras and display limitations of the external display device. As a result, the HMD displays the presented video content on the external device at a reduced quality (e.g., lower clarity, color accuracy, and overall fidelity), failing to fully utilize the HMD's display capabilities. For instance, if the HMD supports HDR content, video received through the HMD camera feed may lack the brightness, contrast ratios, and color depth of video rendered directly on the HMD.

In some approaches, the video content from an external device can be requested directly by the HMD, allowing it to access the original display data and render the video at a quality level that maximizes the display capabilities of the HMD. While this approach enhances video quality by leveraging the HMD's advanced display features, it also leads to higher bandwidth consumption, by requiring multiple copies of the content to be streamed to the HMD and the external device, respectively. Moreover, such approach reduces the ability for real-world interactions. For example, the environment around an HMD user may include other people who wish to view the video content as well. If the HMD displays the video without any form of external synchronization or association with the surrounding environment, it creates an isolating experience that limits the opportunity for shared viewing and real-world interaction. Therefore, there is a need for a method that enables an HMD to render video content displayed within the surrounding environment at an enhanced or high quality while also enabling an interactive experience with the surrounding environment.

To help address these problems, systems and methods are disclosed herein for identifying, via an XR device, a user device that is located in a physical environment of the XR device and displaying media content. The XR device displays a pass-through video of the physical environment including a representation, captured by a camera of the XR device, of the user device displaying the media content, the display of the representation being defined (or characterized), at least in part, by a display parameter having at least one first value. The XR device then initiates a wireless connection between the XR device and the user device and receives data associated with the media content being displayed at the user device via the wireless connection. A maximum capability of a display of the XR device in relation to the display parameter is then determined and, based at least in part on the determined maximum capability and the data received via the wireless connection, the representation of the media content is processed to cause the representation of the media content to be defined (or characterized) at least in part by the display parameter having at least one second value instead of the at least one first value. The XR device displays the processed representation of the media content. In some embodiments, the display parameter indicates dynamic range, such that the at least one first value corresponds to standard dynamic range (SDR) video, and the at least one second value corresponds to high dynamic range (HDR) video.

These aspects help overcome the inherent quality loss from presenting an external video using a camera feed while simultaneously providing a seamless and high-fidelity viewing experience. The described methods and systems provide for real-time enhancement of content in an XR environment, to help ensure that an XR device's advanced capabilities are utilized regardless of the video source, therefore allowing the XR device to consistently render all media at the highest possible HDR quality. In addition, HDR content is best rendered when the display capabilities are known. Even if the user device has a higher HDR capability than the XR device, rendering the content directly on the XR device can still result in better visual quality. Thus, tone mapping the HDR content according to the HMD's display capability, as described by the disclosed methods and systems, yields the best visual quality. By automatically retrieving the original video data via a wireless connection upon detecting the video being displayed in the XR device's environment, the viewing experience remains seamless since it may, in at least some circumstances, provide an enhanced video without requiring explicit user inputs.

In some embodiments, processing the media content corresponds to mapping the representation of the media content. In such embodiments, the XR device modifies the brightness and contrast values of the media content based on the luminance capabilities of the XR device. Such techniques, commonly called HDR tone mapping, adapt the content in real time to the capability of the HMD's internal display. The content is therefore adapted to take advantage of the higher brightness, wider color gamut, and greater contrast ratios of the HMD display, instead of just relying on the picture quality of generic video pass-through.

In some approaches, a capability of the camera of the XR device is insufficient to enable the display of the representation of the media content, as captured by the camera, to be defined (or characterized) at least in part by the display parameter having the at least one second value. These cameras and any corresponding sensors tend to not be able to capture high-quality HDR video. Thus, any video that is rendered merely based on the data from the camera/sensors will not be optimized based on the HDR capabilities of the XR device's internal display.

In some embodiments, the display of the media content at the user device is defined (or characterized) at least in part by the display parameter having the at least one second value. In such embodiments, the representation of the media content is processed by conforming the display of the representation of the media content defined (or characterized) at least in part by the display parameter having the first value to the display of the media content defined (or characterized) at least in part by the display parameter having the second value.

In some embodiments, the XR device receives metadata indicating one or more display parameters of the media content being displayed at the user device via the wireless connection. In some embodiments, the XR device also receives the media content via the wireless connection with the user device. In such aspects, the media content needs to be delivered to the local network only one time. The user device receives the media content which it then transmits to the XR device. Such aspects limit the bandwidth needed to display the content at both the XR device and the user device. In some embodiments, the XR device receives the media content via a wireless connection with a content server. In such embodiments, requesting the same content from two different devices may require more bandwidth to ensure efficient and error-free delivery. Nonetheless, metadata and encryption key information can still be retrieved from the user device rather than being requested again from the content server, therefore helping to reduce latency and bandwidth requirements in both content delivery embodiments.

In some instances, the XR device locates the user device in the physical environment by determining that the user device is in a field of view of the XR device and identifying physical characteristics of the user device, such as by using computer vision techniques. In some embodiments, the physical characteristics may include or specify display edges of the user device, display brightness of the user device, contrast differences between the user device and the physical environment, dimensions of the user device, or any other suitable physical characteristic.

In some embodiments, the pass-through video displays a mixed-reality environment. In such embodiments, the XR device calculate virtual coordinates corresponding to the display of the user device within the MR environment. In some approaches, the calculation is based on the identified physical characteristics of the user device. In some instances, the media content is displayed at the calculated virtual coordinates corresponding to the display of the user device within the mixed reality or augmented reality. Thus, when the XR device moves positions within the physical environment, the media content continues to be displayed at the same virtual coordinates corresponding to the display of the user device within the MR environment.

Such aspects contribute to the seamless and high-quality viewing experience of the present disclosure. For example, the XR device tracks the location of the user device within the MR environment (e.g., by employing advanced computer vision and sensor fusion techniques) and overlays the processed media content over the screen of the user device. Thus, from a user perspective the virtual video object appears to still be generated by the user device. Even if the XR device moves positions, the XR device continues to generate the virtual video at the same virtual coordinates, thus maintaining the perception that the video is originating from the user device. In some embodiments, where the physical environment involves users viewing content on their device, overlaying the virtual video onto the user device allows the XR user to remain engaged in real-world interactions while simultaneously watching the video, which appears to originate from the same device. In some embodiments, the XR device is displayed at coordinates within the MR environment selected by the user of the XR device.

In some approaches, displaying the processed media content at the XR device also involves determining that an object is located in front of the display of the user device within the environment. In such embodiments, the XR device creates a mask of the object within the mixed reality or augmented reality environment and refrains from displaying portions of the processed media content covered by the mask of the object within the mixed-reality environment.

These aspects further enhance the viewing experience by rendering the processed video such that it appears integrated into the physical environment. For example, if the user's device is a mobile phone, occluding portions of the processed video that would naturally be obscured by the user's hand helps enhance the perception that the video is originating directly from the user's device.

In some embodiments, the user device continues displaying the media content while the processed media content is displayed at the XR device. In some approaches, the user device stops displaying the media content when XR device begins displaying the processed media content.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1A depicts an illustrative example for an XR device rendering video content presented at a media device based on video data received from the media device, in accordance with some embodiments of this disclosure;

FIG. 1B depicts an illustrative example for an XR device rendering video content presented at a media device based on video data received from a content server, in accordance with some embodiments of this disclosure;

FIG. 1C depicts an illustrative example for an XR device rendering video content presented at a media device based on sensor data, in accordance with some embodiments of this disclosure;

FIG. 2 depicts an illustrative example for identifying a display within an XR environment and tracking a virtual object over the display, in accordance with some embodiments of this disclosure;

FIG. 3 depicts an illustrative example for identifying an occlusion in front of a virtual object and modifying the rendering of the virtual object based on the identified occlusion, in accordance with some embodiments of this disclosure;

FIG. 4 shows illustrative devices and systems for receiving and rendering video data at an XR device, in accordance with some embodiments of this disclosure;

FIG. 5 shows illustrative devices and systems for receiving and rendering video data at an XR device, in accordance with some embodiments of this disclosure;

FIG. 6 is an illustrative flowchart representing communications and interactions between a user, an XR device, and a media device, in accordance with some embodiments of this disclosure;

FIG. 7 is a sequence diagram of the transfer of instructions between an XR application, a media device, and a content server during the process of the XR device rendering video content currently being presented at the media device, in accordance with some embodiments of this disclosure;

FIG. 8 is a sequence diagram of the transfer of instructions between an XR application, a media device, and a content server during the process of the XR device rendering video content currently being presented at the media device, in accordance with some embodiments of this disclosure;

FIG. 9 is an illustrative flowchart for a process of an XR device presenting either a high quality or a standard quality of media content based on detection of and communication with a media device, in accordance with some embodiments of this disclosure; and

FIG. 10 is an illustrative flowchart representing a process for overlaying a virtual object onto virtual coordinates representing an external display in an environment and refraining from rendering video content portions that are occluded by a physical object in the environment, in accordance with some embodiments of this disclosure.

### DETAILED DESCRIPTION

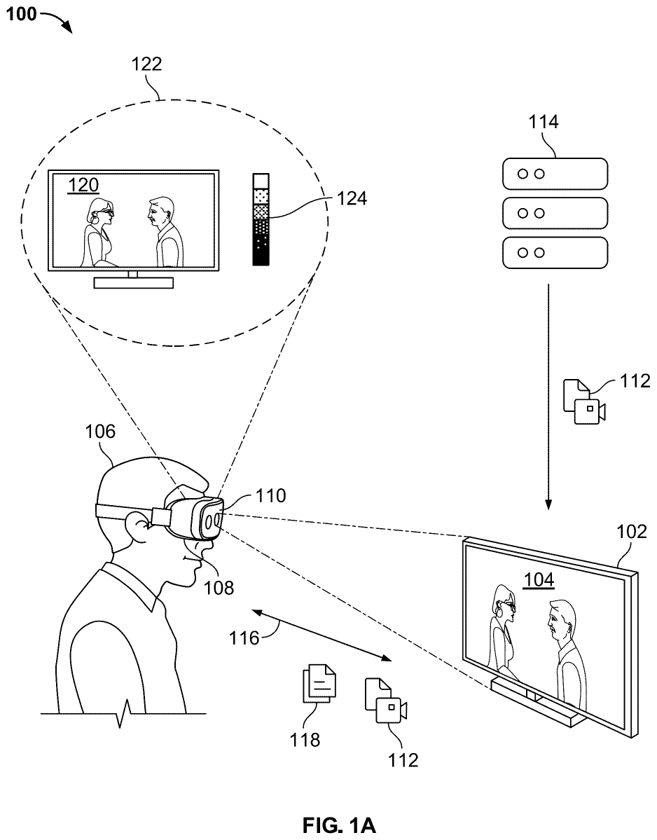

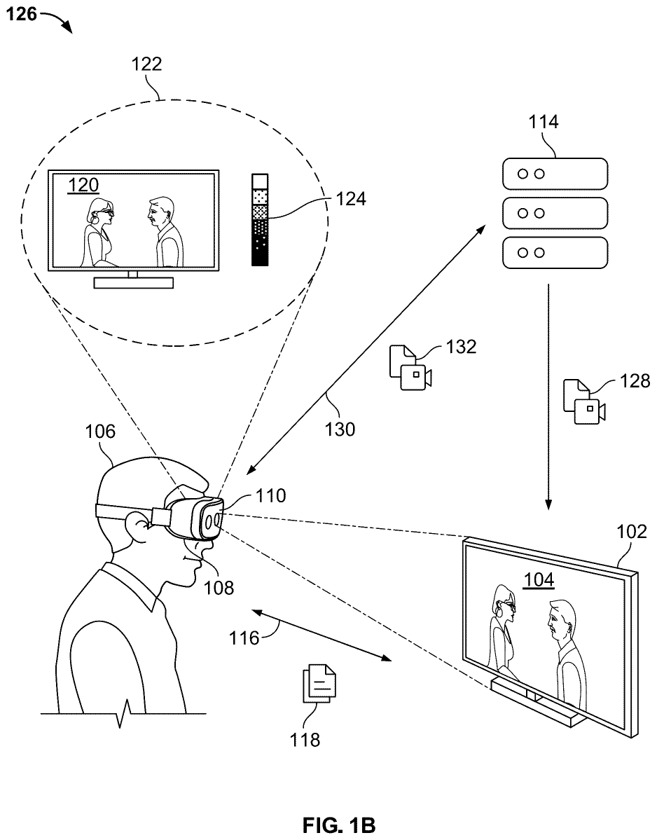

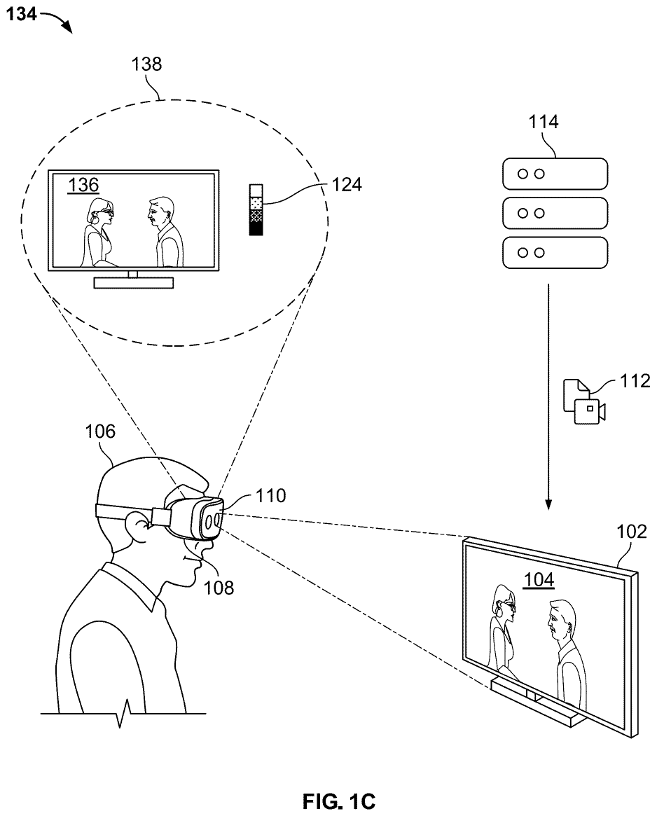

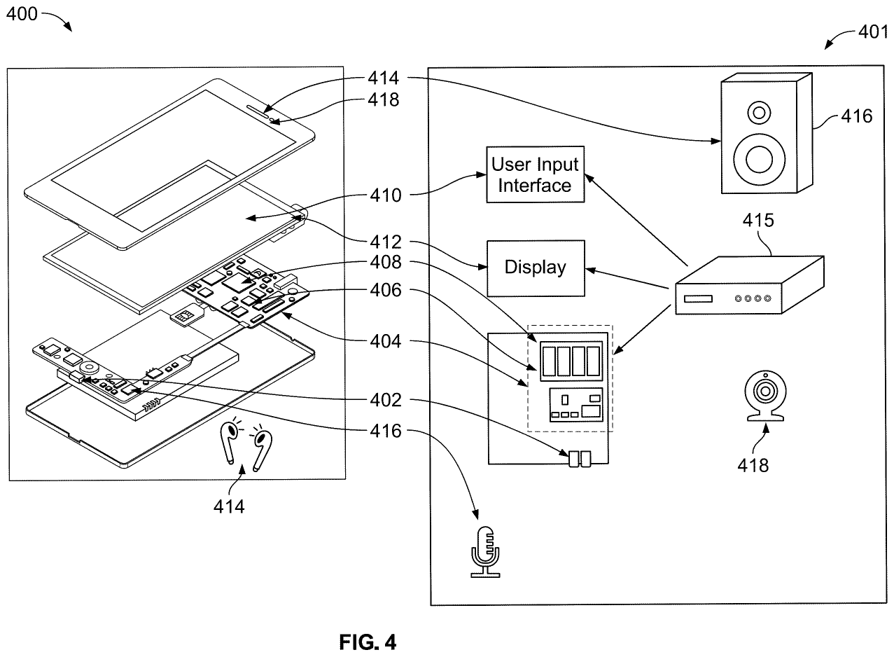

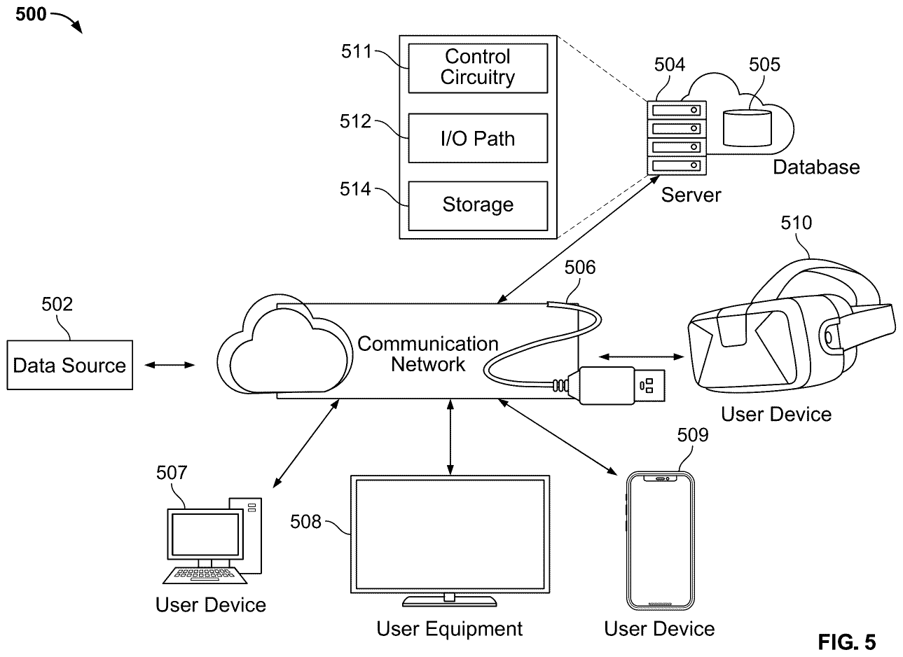

FIG. 1A depicts streaming scenario 100, in which video content presented at a media device (e.g., device 400 of FIG. 4 and/or user equipment devices 507, 508, 509, 510 of FIG. 5) is rendered by an XR device using video data received from the media device presenting the video content, in accordance with some embodiments of this disclosure. Streaming scenario 100 involves a physical environment including media device 102 (e.g., corresponding to device 400 of FIG. 4 and/or user equipment devices 507, 508, 509, 510 of FIG. 5) displaying media content 104. Media device 102 may alternatively be referred to as a display device or a computing device, in some examples. The media content 104 may be displayed or rendered at media device 102 based on video data 112 received from content server 114, or from any other suitable content source. Streaming scenario 100 also involves user 106 wearing XR device 108. XR device 108 is equipped with one or more sensors 110 (e.g., corresponding to camera 418 of FIG. 4 and/or any other suitable sensor(s)) that capture visual and/or spatial data of a particular field of view (FOV) of the physical environment. In some instances, sensors 110 are cameras (e.g., RGB, stereo, monocular), depth sensors (e.g., LiDAR, time-of-flight (ToF), structured light), ultrasonic sensors, radar sensors, or any other suitable sensor for capturing visual and/or spatial data, or any suitable combination thereof. Streaming scenario may involve a single user in the physical environment, or any suitable number of multiple users in the physical environment, e.g., consuming media content 104 in a group setting. In some embodiments, sensors 110 are hardware separate from the XR device, that communicate with the XR device via a wired and/or wireless connection. For example, the physical environment of an XR device may be equipped with sensors 110.

As referred to herein, the terms “media content” may be understood to mean electronically consumable visual user content, such as television programming, as well as pay-per-view programs, on-demand programs (as in video-on-demand (VOD) systems), live content, Internet content (e.g., streaming content, downloadable content, webcasts, etc.), video clips, 3D-content, content information, pictures, GIFs, rotating images, documents, playlists, websites, articles, books, electronic books, blogs, advertisements, chat sessions, social media, applications, games, and/or any other visual media or multimedia and/or combination of the same. In some embodiments, the media asset may be provided for display from a broadcast or stream received at the media device, or from a recording stored in a memory of the media device and/or a remote server. As referred to herein, “media device,” such as, for example, media device 104, refers to any device capable of displaying the aforementioned media content such as a smartphone or tablet,c a laptop computer, a personal computer, a desktop computer, a smart television, a smart watch or wearable device, a projector, a monitor, or any other media device, or any combination thereof.

“XR” may be understood as virtual reality (VR), augmented reality (AR) or mixed reality (MR) technologies, or any suitable combination thereof. VR systems may project images to generate a three-dimensional (3D) environment to fully immerse (e.g., giving a user a sense of being in an environment) or partially immerse (e.g., giving the user the sense of looking at an environment) users in a 3D, computer-generated environment. Such environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world or the real world is otherwise connected to virtual objects.

In some embodiments, the XR device supports video pass-through. In such embodiments, the XR device is equipped with an XR application (e.g., running at least in part on control circuitry 404 of FIG. 4 and/or at server 144, which may correspond to server 504 of FIG. 5, and/or at any other suitable device(s)) that uses the visual and/or spatial data captured by sensors 110 to render a pass-through video-a digital representation of the physical environment including media device 104 and any suitable number of (or types of) objects or other portions—displayed on the device's internal screen (e.g., corresponding to display 412 of FIG. 4). This enables a user to perceive their surroundings without the need to remove the XR device 108, e.g., from their face. As referred to herein, “XR device” refers to any suitable device with video pass-through capabilities such as, for example, head-mounted displays (HMDs), mobile phones, smart glasses, tablets, portable computers, or any other suitable video pass-through-enabled device.

In some instances, the internal display of XR device 108 features advanced display capabilities (as compared to the display capabilities of media device 104) including support for 8K resolution, high dynamic range (HDR), high refresh rates or any other suitable advanced capability for an enhanced visual performance. For example, a display with HDR capabilities offers higher brightness, better contrast, and wider color gamut than many conventional displays. HDR-encoded content may be defined or characterized at least in part by one or more display parameters with corresponding values, e.g., that cause the XR-device to display the content at a higher brightness, better contrast, and wider color gamut. On the other hand, the display of media content 104 by media device 102 may be defined or characterized at least in part by one or more display parameters having at least one value, e.g., support for only lower resolutions, support for SDR, relatively lower refresh rates, or relatively lesser capabilities of any other suitable parameters, in relation to display parameters of XR device 108.

In some embodiments, as shown in FIG. 1C, the pass-through video feed is rendered and displayed without utilizing the XR device's advanced capabilities due to software and hardware limitations of the device. For example, in some instances, sensors 110 have hardware limitations (e.g., camera sensor and resolution limitations) that only enable them to collect sensor data at a quality that is insufficient to leverage the advanced capabilities of the internal display of the XR device. Furthermore, video pass-through may require sensor data to be captured, rendered, and displayed with minimal latency, as any delay may cause motion sickness, disrupt immersion, or misalign virtual objects overlaid on the representation of the physical environment. In some embodiments, the XR device has hardware and/or software limitations that prevent it from rendering and displaying high-quality pass-through video feed quickly enough without causing an unwanted latency increase. In such embodiments, to address potential issues arising from its hardware and/or software limitations, the XR application renders sensor data at a lower quality, forgoing the advanced capabilities of the device's internal display.

In some embodiments, the XR device includes a rendering engine (e.g., which may be part of the XR application, and may be executed at least in part by control circuitry 404 of FIG. 4) that generates virtual objects that the XR application can overlay over the pass-through video, creating an XR environment. Unlike the pass-through video, virtual objects rendered by the rendering engine are generally not subject to the same hardware or software limitations of the XR device. For one, virtual objects are often rendered independent of sensor data, and are therefore unaffected by any hardware limitations of sensors 110. Secondly, while the pass-through video relies on data that is collected in real time, the rendering engine can take advantage of techniques such as predictive rendering, background pre-rendering, frame buffering, multi-frame rendering, any other suitable rendering technique, or any combination thereof, to render content within a more flexible latency constraint. The rendering engine is thus afforded more time to render; that time allowing it to render content compatible with the XR device's advanced capabilities.

Since XR device 108 generally can render virtual objects at a higher quality than it can the pass-through video, in some embodiments, it is preferable to render media content as a virtual object (e.g., an enhanced version of digital representation 136 of FIG. 1C) within the XR environment rather than viewing it via the pass-through video. For example, in streaming scenario 100, user 106 orients the FOV of the XR device 108 towards media device 102 to view media content 104. In some embodiments, media content 104 is capable of being displayed at a high-quality level (e.g., media content 104 is HDR content). However, as noted above, XR device 108 may be constrained by software and/or hardware limitations that prevent the pass-through video feed from displaying content that is compatible with the advanced capabilities of the internal display. Similarly, in some embodiments, media device 102 may not be capable of displaying media content 104 at a high-quality level. For example, one or more values of display parameter(s) defining or characterizing the display of media content 104 at media device 102 may differ from one or more values of display parameter(s) defining or characterizing the display of media content 104, e.g., virtual object 120. Thus, displaying media content 104 through the pass-through video feed (as initially received via one or more sensors of XR device 108, and prior to merging the pass-through feed with virtual objects) would not capitalize on the XR device's advanced internal display capabilities.

Streaming scenario 100 demonstrates a technique that enables XR device 108 to provide a continuous pass-through video while efficiently rendering a virtual version of media content 104 that is compatible with the XR device's advanced internal display capabilities. For example, XR device 108 detects media device 102 within its surroundings and determines that media content 104 is being presented within its FOV. In some embodiments, the XR device detects media device 102 using standard wireless communication discovery protocols such as Bluetooth pairing, Wi-Fi Direct, 802.11ad, or through a local area network (LAN) or any other suitable wireless communication discovery protocol, or using any other suitable technique, or any suitable combination thereof. In some embodiments, XR device 108 determines that media content 104 is being presented within its FOV by utilizing computer vision algorithms and techniques that enable it to identify a surface corresponding to a device screen. In such embodiments, the XR device may utilize computer vision algorithms and techniques such as feature and detection matching techniques, image segmentation, object detection and recognition algorithms, optical flow and motion estimation techniques, deep learning algorithms, pose estimation techniques, any other suitable computer vision techniques and/or algorithms, or any combination thereof. As another example, a wireless signal (e.g., discovery signal) broadcast or received by media device 102 and/or XR device 108, and/or exchange of any other suitable data, may be used to determine that media content 104 is being displayed in a vicinity of media device 102.

After detecting media device 102 and determining that media content 104 is within a FOV of the sensors 110, the XR application establishes wireless connection 116 (e.g., a direct, low-latency connection) between XR device 108 and media device 102. In some embodiments, the communication protocol used to establish wireless connection 116 is based on Wi-Fi, Bluetooth, Miracast, or any other suitable communication protocol that facilitates low-loss, real-time data transfer between devices. In some embodiments, a wired connection may be utilized between XR device 108 and media device 102.

In some embodiments, the XR application initially requests and receives content metadata 118 (e.g., from content server 114 or media device 102) to determine whether video data 112 for rendering media content 104 is encoded to be compatible with the advanced display capabilities of XR device 108 (e.g., content metadata indicating whether the video data is encoded as HDR content). If compatibility is confirmed, XR device 108 receives video data 112 corresponding to the media content 104, originally obtained from the content server 114, through a real-time transfer via wireless connection 116. In some embodiments, the transfer of video data 112 also includes the transfer of audio data. In some embodiments, receiving video data 112 is prompted by a user input such as a gesture, voice input, touch input, or any other suitable input. In some embodiments, XR device 108 automatically requests and receives video data 112 when compatibility has been determined. In some embodiments, determining compatibility also involves exchanging device information between the XR device 108 and the media device 102 to verify whether both devices are configured to establish wireless connection 116 and/or that they are configured to transfer video data 112 via wireless connection 116. In some embodiments, the connection process includes an initial handshake that involves the exchange of encryption keys, ensuring both devices are authenticated, and that connection is secure. In some embodiments, the XR application requests video data 112 irrespective of whether the data is compatible with the advanced display capabilities of XR device 108.

In some embodiments, the XR application has the option to request video data 112 directly from content server 114, as demonstrated by streaming scenario 126 of FIG. 1B. In such embodiments, requesting video data corresponding to the same media content 104 may overload the available bandwidth of a network that XR device 108 and media device 102 are connected to. In such embodiments, XR device 108 may detect the network's bandwidth limitations and opts to receive video data 112 from media device 102 as shown FIG. 1A. This helps prevent network congestion by minimizing bandwidth strain, as the video data is requested from a single device rather than multiple devices. In some embodiments, the XR application switches from requesting video data from content server 114 (as described in FIG. 1B) to receiving it from media device 102 (as described in FIG. 1A) upon detecting that network bandwidth strain is degrading the rendering quality of virtual object 120 (e.g., bandwidth strain is causing transmission delays and data corruption).

In some embodiments, the wireless connection used to transfer video data 112 is a Wi-Fi Direct connection, a Miracast connection, or any other suitable connection that enables smooth, real-time data transfer without introducing significant latency or degradation of content quality. In some embodiments, the XR device uses Bluetooth for initial pairing with media device 102 via a low-bandwidth communication and then transitions to a wireless protocol (e.g., Wi-Fi) capable of high-bandwidth data transfer to facilitate the transmission of video data 112.

When XR device 108 receives video data 112, the rendering engine renders a virtual object 120, e.g., a virtual representation of media content 104. By rendering virtual object 120 based on the unaltered high-quality video data (e.g., video encoded at its native resolution with HDR metadata) originating from content server 114, the rendering engine bypasses the quality limitations inherent in sensor data from sensors 110 (e.g., reduced resolution, compression artifacts, and distortion). This enables the rendering engine to process an accurate and high-quality rendering of virtual object 120. In some embodiments, the display of virtual object 120 may be defined as one or more values that correspond to a higher-quality display experience than, or a consistent display experience with, the display experience of media content 104 at media device 102 being provided based on one or more values for one or more display parameters defining display of media content 104 at media device 102. In some embodiments, the display of virtual object 120 may be defined as one or more values that correspond to a higher-quality display experience, as compared to one or more values of display parameters for digital representation 136 (shown in FIG. 1C). In some embodiments, the rendering engine uses the processing power of both media device 102 and XR device 108 to render virtual object 120.

In some embodiments, media content 104 and virtual object 120 are each defined by a respective max content light level (MaxCLL) parameter with a corresponding value. For example, media content 104 may be defined by a MaxCLL of less than 300 nits, while virtual object 120 may be defined by a MaxCLL value of over 1,000 nits. In some embodiments, media content 104 and virtual object 120 are each defined by a respective max frame-average light level (MaxFALL) parameter with a corresponding value. For example, media content 104 may be defined by a MaxFALL of less than 100 nits, while virtual object 120 may be defined by a MaxFALL value of over 1,000 nits. In some embodiments, media content 104 and virtual object 120 are each defined by a respective bit depth parameter with a corresponding value. For example, media content 104 may be defined by a bit depth value of 8 bits, while virtual object 120 may be defined by a bit depth value of 10 or 12 bits. In some embodiments, media content 104 and virtual object 120 are each defined by a respective color primaries parameter with a corresponding value. For example, media content 104 may be defined by a color primaries value of BT.709, while virtual object 120 may be defined by a color primaries value of BT.2020. In some embodiments, media content 104 and virtual object 120 are each defined by a respective resolution parameter with a corresponding value. For example, media content 104 may be defined by a resolution value of 1920×1080 or lower, while virtual object 120 may be defined by a resolution value of 3840×2160 or higher. In some embodiments, media content 104 and virtual object 120 are each defined by a respective resolution parameter with a corresponding value. Media content 104 and virtual object 120 may each be defined by any combination of parameters and corresponding values, including those mentioned above and any other suitable parameter and corresponding value for defining how the respective content is rendered and displayed.

In some embodiments, media device 102 is capable of only displaying 2D content, but XR device 108 is capable of displaying content that is stereoscopic, 6DOF, panoramic, any other advanced media format, or any combination thereof. In such embodiments, XR device 108 may request video content 112 from media device 102 or content server 114 (as described in FIG. 1B), to receive video content that can be rendered in one of the advanced video formats.

In embodiments where video data 112 is encoded to be compatible with the advanced display capabilities of the XR device (e.g., the video data is encoded as HDR content including one or more of the advanced parameter values mentioned above), the XR application performs additional processing steps that adapt video data 112 to the capabilities of the XR device 108 (e.g., for display as virtual object 120). For example, in some instances, the internal display of the XR device supports various HDR standards, including HDR10, HDR10+, Dolby Vision, or any other suitable HDR content. In such instances, after decoding video data 112, the rendering engine applies HDR tone mapping to video data 112 to optimize it to the brightness, color gamut, and contrast ratios of the XR device display. For example, tone mapping a frame of video data 112 may include modifying the pixel values of that particular frame to be compatible with the brightness, color gamut, and contrast ratio capabilities of the XR device's display.

In some embodiments, the rendering engine uses dynamic tone mapping algorithms to continuously adjust the content's brightness and contrast based on the specific scene being displayed. This ensures that bright scenes appear vivid and dark scenes maintain deep blacks. In some embodiments, the physical display uses a different color space than the XR device (e.g., Rec. 709 vs. Rec. 2020). In such embodiments, the rendering engine performs real-time color space conversion, ensuring the colors are accurately represented on the XR device's display. These additional processing steps during the rendering of virtual object 120 allow the ultimately displayed virtual object 120 to deliver a richer visual experience—not only surpassing the quality of media content viewed through the pass-through feed but, in some embodiments, also exceeding what the media device 102 could achieve on its own.

In some embodiments, the XR application overlays virtual object 120 onto the area where the pass-through video representation of media content 104 is currently being displayed within XR environment 122, effectively covering up and replacing the lower-quality representation of media content 104 that is rendered based on sensor data from sensors 110. By rendering virtual object 120 within the same area as media content 104, the XR application creates an immersive XR environment that accurately reflects the XR device's surroundings while delivering a significantly enhanced visual experience that leverages the advanced capabilities of XR device 108 (e.g., display capabilities, such as, for example HDR, resolution support, codecs support, formats support, and/or any other suitable capability). Overlaying virtual object 120 in this manner effectively simulates the experience of viewing media content 104 in high quality directly on media device 102 (e.g., virtual object 120 presents an HDR adapted version of the media content as indicated by broad brightness spectrum 124). In some embodiments, the XR application determines one or more display parameters and capabilities of XR device 108 based at least in part on a device identifier, which may be a descriptive attribute such as, for example, at least one of the device name, device type, model number, serial number, or manufacturer name, which can be used to look up (e.g., by accessing database 505) capabilities of XR device 108. In some embodiments, virtual object 120, media content 104 presented at media device 102, and/or the representation of media content 104 displayed in the video pass-through feed all correspond to HDR content. However, virtual object 120 may be encoded with parameter values that correspond to a higher HDR image quality than the image quality of media content 104 presented at media device 102, and the image quality of representation of media content 104 displayed in the video pass-through feed.

In some embodiments, media device 102 turns off its display or reduces its brightness once the internal display of XR device 108 begins displaying virtual object 120 (e.g., to conserve power, such as, for example, for a battery-powered device or power within a home, within the physical environment, and/or to conserve network bandwidth). In such embodiments, the XR application may initially determine whether other users are present in the physical environment (e.g., using the computer vision algorithms, or any other suitable techniques). If no other users are present, the XR application instructs media device 102 to turn off or reduce its brightness or provides a prompt to user 106 requesting permission to do so. In some embodiments, where the XR application detects other users, it does not transmit such instructions, or provides a prompt to one or more users requesting permission to do so.

In some embodiments, the XR application communicates, e.g. via wireless connection 116, with media device 102 to ensure that the presentation of the content of virtual object 120 is synchronized with the presentation of the content of media content 104. In some embodiments, the XR application detects the audio playing from media device 102 and matches the detected audio to a playing position of the content of virtual object 120 in order to maintain synchronization. Ensuring synchronization between the presentation of the content of virtual object 120 and the content of media content 104 guarantees that a user of XR device 108 experiences seamless interactions between the virtual objects and the physical environment, particularly when other people are present in the physical space.

In some embodiments, the process from initiating the connection with media device 102 to rendering visual object 120 causes added latency to the displaying of visual object 120. In such embodiments, the XR application may utilize transitioning tools, such as, for example, temporal filtering and blending of video data 112 with sensor data, to ensure a seamless transition between the high-quality and low-quality versions of media content 104 within the XR environment. In some implementations, these transitioning tools feature adjustable parameters (e.g., blending weights, transition duration, etc.) that can be modified based on the quality levels being transitioned (e.g., SDR to HDR, or HDR to SDR). In some embodiments, the HDR tone mapping or adaptation can be configured to render for a changing target so that it starts with a mapping target of the physical display and gradually transitions to the target of HMD display. This can ensure the adaptation results to present a graceful variation in the video experience over time.

In some embodiments, the XR application can add additional virtual objects to the XR environment such as contextual information, navigation aids, interactive elements, or any other suitable additional virtual objects. Virtual objects such as contextual information may correspond to information that is not observable in the physical environment. Conversely, virtual objects like interactive elements may be replacements for objects that are also observable in the physical environment (e.g., TV remote buttons). In some embodiment, the XR device is toggled on and off from rendering virtual object 120 based on receiving a gesture input, voice input, touch input or any other suitable input.

FIG. 1B depicts streaming scenario 126 in which video content presented at a media device is rendered by an XR device using video data received from a content server, in accordance with some embodiments of this disclosure. Streaming scenario 126 presents the same situation as streaming scenario 100, in which user 106 wearing XR device 108 views media content 104 playing from media device 102 via the pass-through video displayed by XR device 108. As in streaming scenario 100, the XR device 108 establishes a wireless connection 116 with the media device 102 and exchanges content metadata 118. The XR application uses content metadata 118 to determine whether video data 128 for rendering media content 104 at media device 102 is encoded to be compatible with the advanced display capabilities of XR device 108 (e.g., content metadata indicating whether the video data is encoded as HDR content). In some embodiments, content metadata 118 may additionally or alternatively be received at XR device 108 from content server 114.

Unlike streaming scenario 100, streaming scenario 126 represents embodiments where the XR application determines that video data 128 is incompatible with the display capabilities of XR device 108. In such embodiments, the XR application establishes a connection 130 between XR device 108 and content server 114 (e.g., corresponding to content server 504 of FIG. 5) to request and receive video data 132 (e.g., stored at storage 514 and/or database 505 of FIG. 5) encoded to be compatible with the XR device's display capabilities (e.g., the content is encoded as HDR content). For example, XR device 108 may connect to an LAN provided by a router in the physical environment, which in turn may be connected to a modem, which in turn is connected to the Internet, to facilitate communication between content server 114 and XR device 108 via connection 130. In some embodiments, the transfer of video data 132 also includes the transfer of audio data. After receiving video data 132 from content server 114, the rendering engine uses the data to render virtual object 120, and the XR application overlays it into the XR environment 122 in the same manner that is disclosed in the description of FIG. 1A. Thus, even if video data 128 retrievable from media device 102 is incompatible, the XR application can still retrieve compatibly encoded video data 132 from content server 114 to render an accurate and high-quality version of media content 104 (e.g., as shown by broad brightness spectrum 124), thereby bypassing the quality limitations of sensor data from sensors 110.

In some embodiments, the XR application requests and receives video data 132 from content server 114 based on determining that media device 102 is not configured to transfer high-quality video data via wireless connection 116. In some implementations, the data transfer process between XR device 108 and media device 102 includes an initial handshake involving the exchange of encryption keys. For example, when media device 102 requested video data 128, it may have initially completed a digital rights management (DRM) authentication process to receive a license with a corresponding encryption key for accessing video data 128. As a result of exchanging encryption keys via the initial handshake, the XR application is not required to repeat the DRM authentication process when subsequently requesting video data 132 from content server 114. In some embodiments, XR application requests video data 132 from content server 114 regardless of the compatibility of video data 128 and media device 102.

FIG. 1C depicts streaming scenario 134 in which video content presented at a media device is rendered by an XR device using sensor data, in accordance with some embodiments of this disclosure. In streaming scenario 134, the XR application renders a digital representation 136 of media content 104 as part of the pass-through video 138 using sensor data from sensors 110. The quality of digital representation 136 is therefore mitigated by the hardware and/or software limitations of sensors 110 and XR device 108, causing potential reduced resolution, compression artifacts, distortion, any other unwanted quality loss, or any combination thereof. Furthermore, even if sensors 110 are capable of capturing high-quality video data, the display of media device 102 presenting media content 104 may also have hardware limitations that are below the quality level achievable by the inner display of XR device 108 (e.g., media device 102 displays SDR content and XR device 108 is capable of displaying HDR content).

By relying only on sensor data from sensors 110, digital representation 136 presents an unenhanced version or a low-quality rendering of media content 104 (e.g., the content was not created and encoded in HDR as indicated by the narrow brightness spectrum 140). Not presenting the enhanced version or high-quality rendering of media content in an environment may detract from the viewing experience for user 106, which in turn may discourage interactions with the environment while wearing the XR device and disincentivize using the device in pass-through mode, often causing user 106 to remove it altogether. This highlights some advantages of the aforementioned solutions described in streaming scenario 100 of FIG. 1A and streaming scenario 126 of FIG. 1B, as they maintain engagement and deliver a seamless, high-quality XR-viewing experience. In some embodiments, digital representation 136 is displayed (or is not displayed) via XR device 108 prior to the XR application performing the processing to provide for display, at XR device 108, the enhanced version of media content 104, using the techniques described herein.

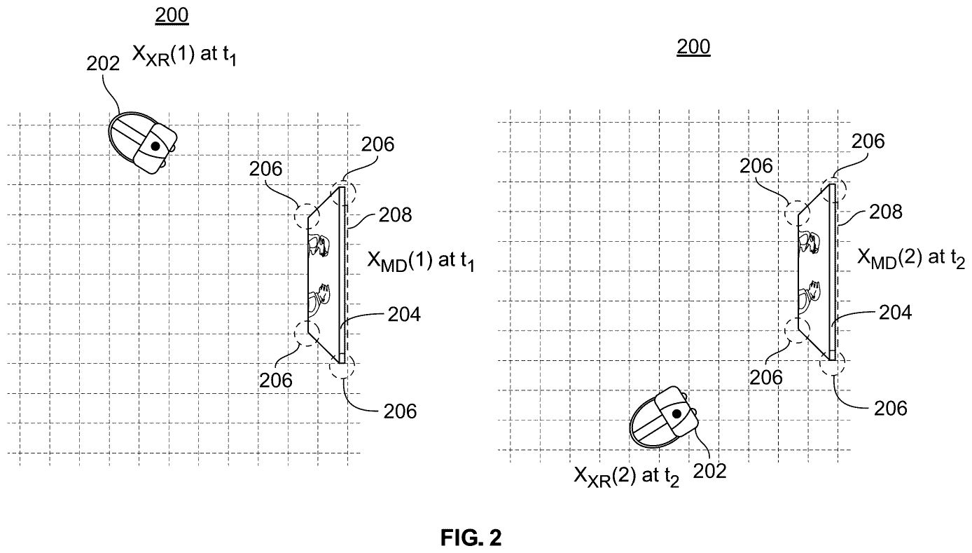

FIG. 2 depicts an illustrative example for identifying a display 204 within an XR environment and tracking a virtual object over the display, in accordance with some embodiments of this disclosure. In some embodiments, the XR application (e.g., running at least in part on control circuitry 404 of FIG. 4) renders a virtual object representing a high-quality version of the media content at a designated position within the XR environment. In certain instances, this designated position aligns with the location of display 204 presenting the media content, as captured, and represented by the pass-through video (e.g., displayed on display 412 of FIG. 4). By positioning the virtual object in this manner, only the virtual object-offering the higher-quality version of the media content—is visible as a perceived output of XR device 202 in the XR environment, creating the perception that it is still being presented by the physical display of display 204 in the environment.

In some embodiments, to accurately overlay the virtual object over the physical display within the XR environment, the XR application anchors the virtual object to spatial points within the XR environment. In such embodiments, the XR application utilizes computer vision and sensor fusion algorithms to generate a spatial map of the physical environment by identifying physical characteristics of objects within the environment, such as edges, brightness, contrast differences, or any other suitable physical characteristics. A spatial map serves as an underlying 3D coordinate structure for an XR environment, where identified planes, edges, and features of objects and surfaces are represented by several spatial points within the 3D coordinate structure. Using the spatial mapping (or in some embodiments 2D image data), the XR application identifies the edges of a display within the environment. Once the edges are detected, the XR application identifies the four corners of the display by analyzing the intersections of the display's borders. In some embodiments, since the display may be viewed from different angles (non-perpendicular), the XR application performs perspective correction to adjust the coordinates of the four corners of the identified display in the spatial map. This corrects any distortions caused by the viewing angle and helps to ensure accurate rendering. Once the XR application determines coordinates corresponding to the display, the application stores (e.g., at storage circuitry 408 of FIG. 4 and/or storage 514 of FIG. 5) the determined coordinates as anchor points for rendering the virtual object for the media content.

In some embodiments, the XR application utilizes feature mapping techniques to identify a quadrilateral region at which to render the virtual object corresponding to the media content. In such embodiments, the XR application compares the known frames of the video content with image data captured by the XR devices sensors. In such embodiments, the XR application may match a known frame to a particular portion of the captured image data that corresponds to the display region of display 204. The XR application may then identify that particular portion as the location for where to render the virtual object. In such embodiments, matching a known video frame to the frame currently displayed by display 204 also helps ensure that the rendered virtual content is synchronized with the content displayed in the physical environment.

FIG. 2 depicts XR device 202 located at coordinate(s) X_{XR}(1) of the spatial map of the XR environment 200 at a first time. The XR application has determined—based on computer vision algorithms, edge detection algorithms, the spatial map, or any combination thereof—that physical display presenting media content is located at coordinate(s) X_{MD}(1). Based on having identified the display, the XR application determines the coordinates of corners 206 and/or edges 208 and stores them as anchor points for rendering the virtual object representing a high-quality version of the media content over the physical display within the XR environment. When the XR application renders the virtual object at the stored anchor points, it creates the experience that the virtual object is seamlessly integrated into the physical environment. This gives the impression that the high-quality version of the media content is still being presented by the physical display.

In some embodiments, to make the experience more robust, the XR application continuously tracks the anchors points' positions and orientation relative to the device in real time (e.g., using pose estimation) and dynamically adjusts the rendering of the virtual object to maintain alignment. In some embodiments, the XR application employs feature tracking algorithms such as Kanade-Lucas-Tomasi algorithms, optical flow algorithms, any other suitable feature tracking algorithm, or any combination therefore, to track the anchor points. Thus, even if the orientation of the device is moved and/or tilted, the XR application keeps track of the exact anchor points where the virtual object needs to be rendered. In some embodiments, using the tracked anchor points, the system performs pose estimation to determine the display's orientation and position relative to the XR device.

FIG. 2 depicts XR device 202 located at coordinate(s) X_{XR}(2) of the spatial map of XR environment 200 at a second time. While XR device 202 moves from X_{XR}(1) to X_{XR}(2), the XR application continuously tracks the stored anchor points for the coordinates of corners 206 and/or edges 208. This tracking enables the application to consistently render the virtual object representing a high-quality version of the media content at those anchor points. The experience that the high-quality version of the media content is still being presented by the physical display is therefore sustained even if the XR device moves around the XR environment.

In some embodiments, the technique for tracking the anchor points involves the computation of a homography matrix, which defines the transformation between the detected quadrilateral shape of the display (as seen by the user) and the ideal rectangular coordinate system. In such embodiments, the homography matrix allows the system to accurately project the HDR content onto the display, regardless of the angle and orientation of the XR device 202 with respect to display 204. In such embodiments, once the XR application has calculated the coordinates representing the physical display, it maps the HDR content to this specific window using the homography matrix. The content is then rendered within the XR environment, ensuring it aligns with the physical display. As the XR device changes positions, the XR application dynamically updates the homography matrix and adjusts the rendered HDR content accordingly, ensuring that the content stays accurately aligned with the physical display in real time.

In some embodiments, computer vision techniques and/or algorithms utilized for identifying planes, edges, and features within the physical environment include feature and detection matching techniques; image segmentation; object detection and recognition algorithms; optical flow and motion estimation techniques; deep learning algorithms; pose estimation techniques; any other suitable computer vision techniques and/or algorithms; or any combination thereof. In some embodiments, sensor fusion techniques and/or algorithms utilized for generating spatial maps of an environment and tracking spatial points within that spatial map include SLAM algorithms, multi-sensor integration techniques; localization and tracking algorithms; data association techniques; any other suitable sensor fusion techniques and/or algorithms; or any combination thereof.

In some embodiments, the virtual object is rendered on a virtual display boundary other than the identified coordinates corresponding to the physical display. For example, in such embodiments, the XR device may receive user inputs defining a rectangular space in the FOV of the XR device's sensors, such as an empty wall space adjacent to the physical display. Such embodiments allow a user to reposition, reorient, and/or resize the content from the physical display into the XR environment.

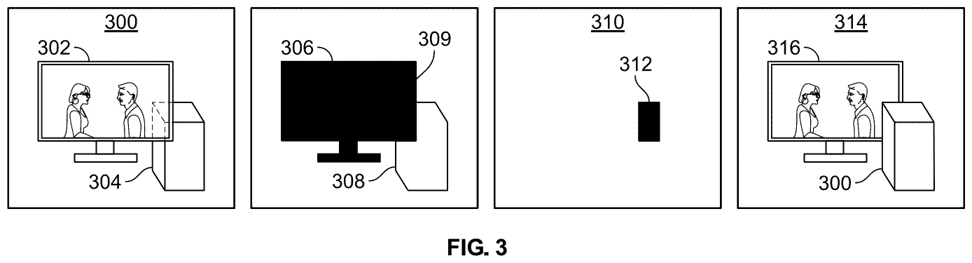

FIG. 3 depicts an illustrative example for identifying an obstruction in front of a virtual object and modifying the rendering of the virtual object based on the identified obstruction, in accordance with some embodiments of this disclosure. In some embodiments, objects may obstruct the XR device's sensors (e.g., camera 418 of FIG. 4), limiting their ability to capture a full view of a display screen in the physical environment for the pass-through video. In such embodiments, simply overlaying a virtual representation of the media content onto the coordinates of the display screen (e.g., display 412 of FIG. 4) in the calculated spatial map would not account for the obstruction and provide an accurate video pass-through of the real-world environment. As a result, displaying the virtual representation over an object blocking the actual media content breaks the illusion that the virtual content is still emanating from the physical display screen.

In some embodiments, to maintain the aforementioned experience, the XR application (e.g., running at least in part on control circuitry 404 of FIG. 4) continuously monitors for obstructions between the XR device's sensors and portions of the display screen presenting the media content. If the XR application detects an obstruction of the display screen, the XR application renders the virtual representation of the media content to not include what would be the obstructed portions of the media content in the physical environment. In some embodiments, the XR application employs object detection algorithms such as You Only Look Once (YOLO), Mask R-convolutional neural network (CNN), Faster R-CNN, Detection Transformer (DETR), Single Shot MultiBox Detector, RetinaNet, any other suitable object detection algorithm, or any suitable custom implementation thereof, or any combination thereof, to detect objects obstructing the display screen of a media device. In some embodiments, the obstruction is a hand. For instance, the user of the XR device may wish to use their hand(s) for gesture controls and/or to interact with the real-world environment. In such embodiments, it would therefore be desirable for the XR environment to present the user's hand(s) in front of any virtual objects. For example, the media device may be a mobile phone with a touchscreen, and the hand remains visible in front of the virtual representation of the media content to maintain a consistent user experience. In some embodiments, the obstruction is any object (e.g., pillars, boxes, a person, a pet, etc.) in a physical environment placed between an XR device and a display screen. For example, the XR device may be displaying XR environment 300, including virtual object 302 and physical object 304. The physical object covers at least a portion of the FOV of the physical display from the perspective of the XR device and/or the user of the XR device, and the XR application identifies the object as an obstruction to be accounted for in the rendering of virtual object 302. In embodiments where the XR device is equipped with depth sensors (e.g., LiDAR, stereo cameras, and/or any other suitable sensors), the sensors are used to assist in detecting obstructions by measuring the distance between the display and objects in front of it.

In some embodiments, when the obstructing object is detected, the XR application segments the object, the obstructing portion of the object, and other relevant portions of the physical environment, e.g., based on semantic segmentation algorithms such as thresholding, clustering, region-based segmentation, graph-based segmentation, Fully Convolutional Network (FCN), U-Net, DeepLab, any other suitable semantic segmentation algorithms, or any combination thereof. For example, in the obstruction scenario of XR environment 300, the XR application segments the physical display into display segmentation 306, and the obstructing object into object segmentation 308. Based on segmenting the object, the XR application is able to identify portions of the virtual object that intersect with the obstructing object to generate obstruction segmentation 309. In such embodiments, the XR application separates the object from the rest of the XR application so that it knows where not to render the virtual object.

In some embodiments, based on the derived segmentation information, the XR application generates a binary mask to specified areas of the XR environment where virtual object 302 should not be rendered. For instance, in the obstruction scenario of XR environment 300, the application generates mask 310 with exclusion region 312, indicating the portions of the XR environment where not to render virtual object 302.

In some implementations, the XR application then includes the binary mask in the rendering pipeline of the rendering engine. As shown in XR environment 314, the rendering engine renders virtual object 316 while leaving the exclusion region 312 intersecting with object segmentation 308 blank, thereby ensuring that the media content is not rendered over any part of object segmentation 308.

In embodiments where virtual object 316 supports HDR, the rendering engine performs post rendering after rendering virtual object 316 in the appropriate areas of the XR environment. In such embodiments the rendering engine reintegrates the segmented obstructing objects into the rendered frames or video. This ensures that obstructing objects (e.g., a hand) appear on top of the rendered content, maintaining visual continuity and realism.

In some embodiments, the XR application continuously monitors the scene for changes, such as new obstructions (e.g., additional objects blocking the display) or changes in the position of the display. In such embodiments, the XR application dynamically updates the homography matrix, obstruction masks, and rendering process to adapt to these changes in real-time.

FIGS. 4-5 show illustrative devices and systems for receiving and rendering video data at an HMD, in accordance with some embodiments of this disclosure. FIG. 4 shows generalized embodiments of illustrative devices 400 and 401, which may correspond to, e.g., XR device 108 of FIGS. 1A-1C. For example, device 400 may be a smartphone device, a tablet, a virtual reality or augmented reality device, or any other suitable device capable of accessing content items stored at a server (e.g., a content server) over a communication network (e.g., communication network 506) or another device communicatively linked to device 400. In another example, device 401 may be a user television equipment system or device. Device 401 may include set-top box 415. Set-top box 415 may be communicatively connected to microphone 416, audio output equipment (e.g., speaker or headphones 414), and display 412. In some embodiments, microphone 416 may receive audio corresponding to a voice command related to recording content items. In some embodiments, display 412 is the inner display of a head-mounted headset (HMD). In some embodiments, set-top box 415 may be communicatively connected to user input interface 410. In some embodiments, user input interface 410 may be a remote control device. Set-top box 415 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment devices are discussed below in connection with FIG. 5. In some embodiments, device 400 may comprise any suitable number of sensors, as well as a GPS module (e.g., in communication with one or more servers and/or cell towers and/or satellites) to ascertain a location and the physical environment of device 400.

Each one of device 400 and device 401 may receive content and data via input/output (I/O) path 402. I/O path 402 may provide content (e.g., broadcast programming, on-demand programming, Internet content, content available over a local area network (LAN) or wide area network (WAN), and/or other content) and data to control circuitry 404, which may comprise processing circuitry 406 and storage 408. Control circuitry 404 may be used to send and receive commands, requests, and other suitable data using I/O path 402, which may comprise I/O circuitry. I/O path 402 may connect control circuitry 404 (and specifically processing circuitry 406) to one or more communications paths (described below). I/O functions may be provided by one or more of these communications paths, but are shown as a single path in FIG. 5 to avoid overcomplicating the drawing. While set-top box 415 is shown in FIG. 5 for illustration, any suitable computing device having processing circuitry, control circuitry, and storage may be used in accordance with the present disclosure. For example, set-top box 415 may be replaced by, or complemented by, a personal computer (e.g., a notebook, a laptop, a desktop), a smartphone (e.g., device 400), a tablet, a network-based server hosting a user-accessible client device, a non-user-owned device, any other suitable device, or any combination thereof.

Control circuitry 404 may be based on any suitable control circuitry such as processing circuitry 406. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 404 executes instructions for the XR application stored in memory (e.g., storage 408). Specifically, control circuitry 404 may be instructed by the XR application to perform the functions discussed above and below. In some implementations, processing or actions performed by control circuitry 404 may be based on instructions received from the XR application.

In client/server-based embodiments, control circuitry 404 may include communications circuitry suitable for communicating with an XR server (e.g., a cloud DVR, content database) or other networks or servers. The XR application may be a stand-alone application implemented on a device or a server. The XR application may be implemented as software or a set of executable instructions. The instructions for performing any of the embodiments discussed herein of the XR application may be encoded on non-transitory computer-readable media (e.g., a hard drive, random-access memory on a DRAM integrated circuit, read-only memory on a BLU-RAY disk, etc.). For example, in FIG. 4, the instructions may be stored in storage 408, and executed by control circuitry 404 of device 400.

In some embodiments, the XR application may be a client/server application where only the client application resides on device 400 (e.g., computing device 104), and a server application resides on an external server (e.g., content server 504). For example, the XR application may be implemented partially as a client application on control circuitry 404 of device 400 and partially on content server 504 as a server application running at least in part on control circuitry 511. Content server 504 may be a part of a local area network with one or more of device 400 or may be part of a cloud computing environment accessed via the internet. In a cloud computing environment, various types of computing services for performing searches on the internet or informational databases, providing access to content items, providing storage (e.g., for a database) or parsing data are provided by a collection of network-accessible computing and storage resources (e.g., content server 504), referred to as “the cloud.” When executed by control circuitry of content server 504, the XR application may instruct control circuitry 511 to perform processing tasks for the client device and facilitate the recording and presentation of content item. The client application may instruct control circuitry 404 to provide content consumption history.

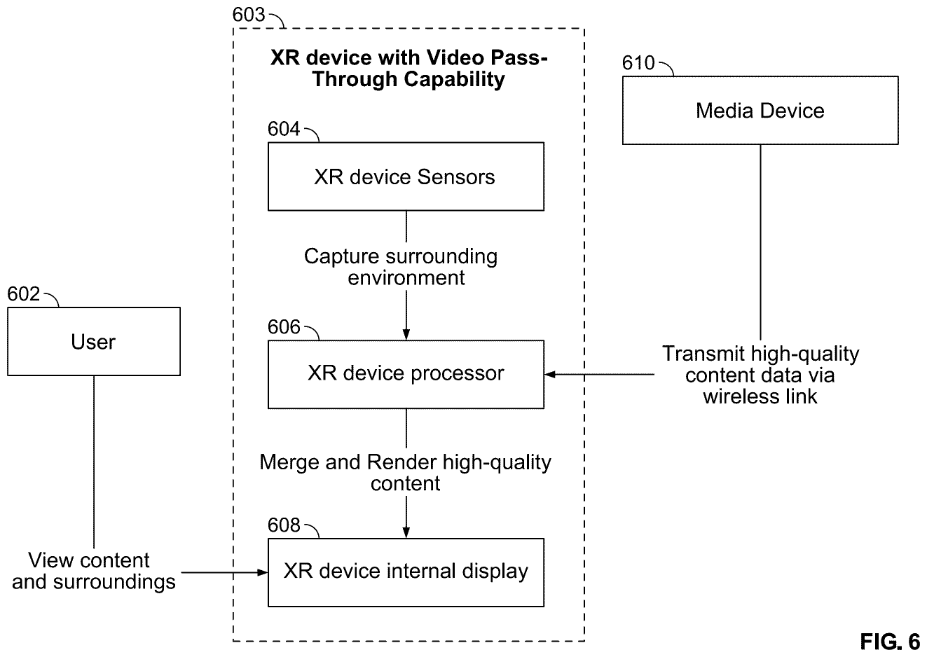

Control circuitry 404 may include communications circuitry suitable for communicating with a cloud DVR, media content source, edge servers and devices, a table or database server, or other networks or servers The instructions for carrying out the above mentioned functionality may be stored on a server (which is described in more detail in connection with FIG. 5). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which are described in more detail in connection with FIG. 6). In addition, communications circuitry may include circuitry that enables peer-to-peer communication of user equipment devices, or communication of user equipment devices in locations remote from each other (described in more detail below).

Memory may be an electronic storage device provided as storage 408 that is part of control circuitry 404. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 408 may be used to store various types of content described herein as well as XR application data described above. Nonvolatile memory may also be used (e.g., to launch a boot-up routine and other instructions). Cloud-based storage, described in relation to FIG. 4, may be used to supplement storage 408 or instead of storage 408.

Control circuitry 404 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 404 may also include scaler circuitry for upconverting and down converting content into the preferred output format of device 400. Control circuitry 404 may also include digital-to-analog converter circuitry and analog-to-digital converter circuitry for converting between digital and analog signals. The tuning and encoding circuitry may be used by device 400, 401 to receive and to display, to play, or to record content. The tuning and encoding circuitry may also be used to receive content item data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 408 is provided as a separate device from device 400, the tuning and encoding circuitry (including multiple tuners) may be associated with storage 408.

Control circuitry 404 may receive instruction from a user by way of user input interface 410. User input interface 410 may be any suitable user interface, such as a remote control, mouse, trackball, keypad, keyboard, touch screen, touchpad, stylus input, joystick, voice recognition interface, or other user input interfaces. Display 412 may be provided as a stand-alone device or integrated with other elements of each one of device 400 and device 401. For example, display 412 may be a touchscreen or touch-sensitive display. In such circumstances, user input interface 410 may be integrated with or combined with display 412. In some embodiments, user input interface 410 includes a remote-control device having one or more microphones, buttons, keypads, any other components configured to receive user input or combinations thereof. For example, user input interface 410 may include a handheld remote-control device having an alphanumeric keypad and option buttons. In a further example, user input interface 410 may include a handheld remote-control device having a microphone and control circuitry configured to receive and identify voice commands and transmit information to set-top box 415.

Audio output equipment 414 may be integrated with or combined with display 412. Display 412 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 412. Audio output equipment 414 may be provided as integrated with other elements of each one of device 400 and device 401 or may be stand-alone units. An audio component of videos and other content displayed on display 412 may be played through speakers (or headphones) of audio output equipment 414. In some embodiments, audio may be distributed to a receiver (not shown), which processes and outputs the audio via speakers of audio output equipment 414. In some embodiments, for example, control circuitry 404 is configured to provide audio cues to a user, or other audio feedback to a user, using speakers of audio output equipment 414. There may be a separate microphone 416 or audio output equipment 414 may include a microphone configured to receive audio input such as voice commands or speech. For example, a user may speak letters or words that are received by the microphone and converted to text by control circuitry 404. In a further example, a user may voice commands that are received by a microphone and recognized by control circuitry 404. Camera 418 may be any suitable video camera integrated with the equipment or externally connected. Camera 418 may be a digital camera comprising a charge-coupled device (CCD) and/or a complementary metal-oxide semiconductor (CMOS) image sensor. Camera 418 may be an analog camera that converts to digital images via a video card.

The XR application may be implemented using any suitable architecture. For example, it may be a stand-alone application wholly-implemented on each one of device 400 and device 401. In such embodiments, instructions of the application may be stored locally (e.g., in storage 408), and data for use by the application is downloaded on a periodic basis (e.g., from an out-of-band feed, from an Internet resource, or using another suitable technique). Control circuitry 404 may retrieve instructions of the application from storage 408 and process the instructions to provide XR functionality and generate any of the displays discussed herein. Based on the processed instructions, control circuitry 404 may determine what action to perform when input is received from user input interface 410. For example, movement of a cursor on a display up/down may be indicated by the processed instructions when user input interface 410 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 404 may allow a user to provide user profile information or may automatically compile user profile information. For example, control circuitry 404 may access and monitor network data, video data, audio data, processing data, content consumption data and user interaction data. Control circuitry 404 may obtain all or part of other user profiles that are related to a particular user (e.g., via social media networks), and/or obtain information about the user from other sources that control circuitry 404 may access. As a result, a user can be provided with a unified experience across the user's different devices.

In some embodiments, the XR application is a client/server-based application. Data for use by a thick or thin client implemented on each one of device 400 and device 401 may be retrieved on-demand by issuing requests to a server remote to each one of device 400 and device 401. For example, the remote server may store the instructions for the application in a storage device. The remote server may process the stored instructions using circuitry (e.g., control circuitry 404) and generate the displays discussed above and below. The client device may receive the displays generated by the remote server and may display the content of the displays locally on device 400. This way, the processing of the instructions is performed remotely by the server while the resulting displays (e.g., that may include text, a keyboard, or other visuals) are provided locally on device 400. Device 400 may receive inputs from the user via user input interface 410 and transmit those inputs to the remote server for processing and generating the corresponding displays. For example, device 400 may transmit a communication to the remote server indicating that an up/down button was selected via user input interface 410. The remote server may process instructions in accordance with that input and generate a display of the application corresponding to the input (e.g., a display that moves a cursor up/down). The generated display is then transmitted to device 400 for presentation to the user.

In some embodiments, the XR application may be downloaded and interpreted or otherwise run by an interpreter or virtual machine (run by control circuitry 404). In some embodiments, the XR application may be encoded in the ETV Binary Interchange Format (EBIF), received by control circuitry 404 as part of a suitable feed, and interpreted by a user agent running at least in part on control circuitry 404. For example, the XR application may be an EBIF application. In some embodiments, the XR application may be defined by a series of JAVA-based files that are received and run by a local virtual machine or other suitable middleware executed by control circuitry 404. In some of such embodiments (e.g., those employing MPEG-2 or other digital media encoding schemes), XR application may be, for example, encoded and transmitted in an MPEG-2 object carousel with the MPEG audio and video packets of a program.

FIG. 5 shows illustrative devices and systems for providing one or more portions of the media asset, in accordance with some embodiments of this disclosure. User equipment devices 507, 508, 509, 510 (e.g., which may correspond to XR device 108 of FIGS. 1A-1C) may be coupled to communication network 506. Communication network 506 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 506) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 5 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 506.

System 500 may comprise media content source 502, and one or more content servers 504. In some embodiments, the XR application may be executed at one or more of control circuitry 511 of content server 504 (and/or control circuitry of user equipment devices 507, 508, 509, 510). In some embodiments, video data 112 of FIGS. 1A-1C, may be stored at storage 514 or content database 505 maintained at or otherwise associated with content server 504, and/or at storage of one or more of user equipment devices 507, 508, 509, 510.

In some embodiments, content server 504 may include control circuitry 511 and storage 514 (e.g., RAM, ROM, Hard Disk, Removable Disk, etc.). Storage 514 may store one or more databases. Content server 504 may also include an input/output path 512. I/O path 512 may provide content consumption data, user interaction data, device information, or other data, over a local area network (LAN) or wide area network (WAN), and/or other content and data to control circuitry 511, which may include processing circuitry, and storage 514. Control circuitry 511 may be used to send and receive commands, requests, and other suitable data using I/O path 512, which may comprise I/O circuitry. I/O path 512 may connect control circuitry 511 (and specifically control circuitry) to one or more communications paths.

Control circuitry 511 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 511 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 511 executes instructions for an emulation system application stored in memory (e.g., the storage 514). Memory may be an electronic storage device provided as storage 514 that is part of control circuitry 511.

FIG. 6 is an illustrative flowchart representing communications and interactions between a user, an XR device, and a media device, in accordance with some embodiments of this disclosure. In some embodiments, the process of rendering and overlaying a high-quality virtual representation of media content involves user 602, XR device 603 (e.g., corresponding to device 400 of FIG. 4 and/or user equipment devices 507, 508, 509, 510 of FIG. 5), and media device 610 (e.g., corresponding to device 400 of FIG. 4 and/or user equipment devices 507, 508, 509, 510 of FIG. 5). The XR device is configured with a video pass-through capability.

The process of presenting the pass-through video involves capturing image/sensor data of the surroundings of XR device 603 using sensor 604 (e.g., corresponding to camera 418 of FIG. 4 and/or any other suitable sensor(s)), rendering the captured data into a representation of the surrounding physical environment of XR device 603 using processor 606 (e.g., corresponding to processing circuitry 406), and displaying the representation on internal display 608 (e.g., corresponding to display 412). The surroundings of XR device 603 changes as the user moves around the surroundings while wearing XR device 603. In some embodiments, media content playing from media device 610 appears in the representation of XR device 603's surroundings. In some embodiments, the image quality of the media content within the representation of XR device 603's surroundings is limited by hardware and/or software limitations of XR device 603 and/or hardware and/or software limitations of media device 610. In some embodiments, media device transmits high-quality content data corresponding to the media content to XR device 603 via a wireless link (e.g., Wi-Fi, Miracast, etc.) (e.g., as demonstrated in streaming scenario 100 of FIG. 1A). In such embodiments, processor 606 combines the rendering of XR device 603's surroundings with the rendering of the media content based on the high-quality content data and displays the merged result on internal display 608.

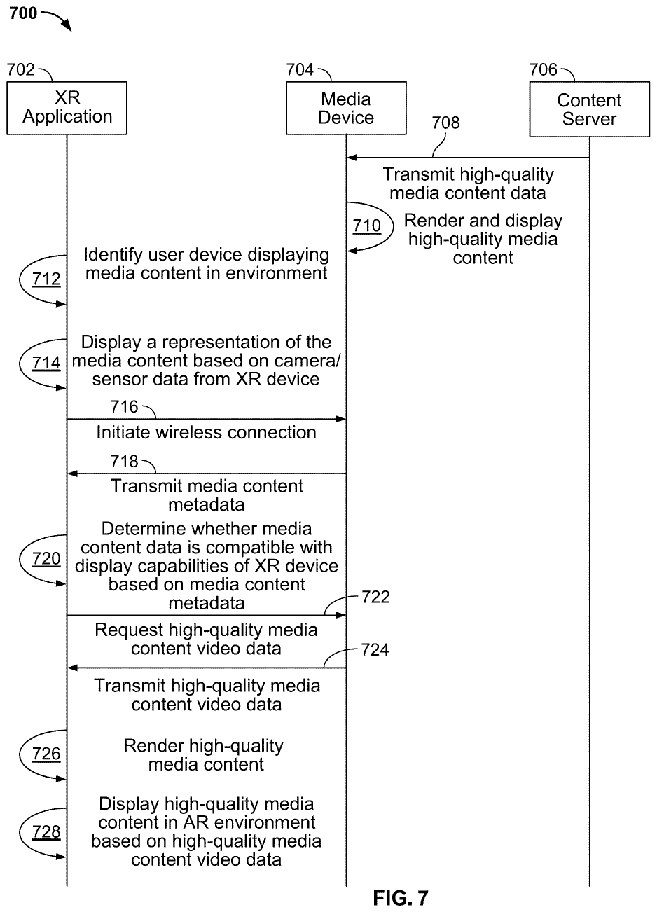

FIG. 7 shows sequence diagram 700 of the transfer of instructions between an XR device, a media device, and content server during the process of the XR device rendering video content currently being presented at the media device, in accordance with some embodiments of this disclosure. In some embodiments, sequence diagram 700 corresponds to the transfer of instructions that occur during streaming scenario 100 depicted in FIG. 1A. At 708, content server 706 transmits high-quality media content data (e.g., media content data that is HDR-encoded) to media device 704. Media device 704 uses the high-quality media content data to render and display a high-quality of media content at 710. At 712, XR application 702 (e.g., running at least in part on control circuitry 404 of FIG. 4) identifies media device 704 displaying the media content in its surrounding environment. In some embodiments, XR application 702 uses standard wireless communication discovery protocols such as Bluetooth pairing, Wi-Fi Direct, 802.11ad, or through a local area network (LAN) or any other suitable wireless communication discovery protocol to identify the media device. At 714, when the media device enters the FOV of the XR device's cameras and/or sensors (e.g., camera 418 in FIG. 4), XR application 702 displays a representation of the media content in a pass-through video presented on the XR device's internal display, based on camera and/or sensor data.

After identifying the media device and displaying a representation of the media content, XR application 702 initiates a wireless connection (e.g., Wi-Fi, Bluetooth, etc.) between the XR device and the media device, at 716. Once the wireless connection is established, at 718 media device 704 transmits media content metadata to XR application 702. At 720 the XR application uses the received media content metadata to determine whether the media content data that media device 704 received from content server 706 is compatible with display capabilities of the XR device running XR application 702. For example, the internal display of the XR device may be HDR-enabled, and XR application 702 uses the received media content metadata to determine whether is HDR-encoded to take advantage of that display capability.

In some embodiments, XR application 702 determines that the media content displayed at media device 704 is being rendered using high-quality media content data, e.g., content data that is compatible with display capabilities of the XR device. In such embodiments, at 722, XR application 702 requests the high-quality media content data from media device 704, via a wireless connection (e.g., Wi-Fi, Miracast, etc.). In some embodiments, XR application 702 requests media content video data from media device 704 regardless of the quality of the media content data and/or the display capabilities of the XR device. At 724, media device 704 transmits the high-quality media content data to XR application 702. At 726, XR application renders the high-quality media content based on the received content data, the XR device's display capabilities, the media content metadata, or any combination thereof, and, at 728, displays the high-quality media content in an XR environment (e.g., the pass-through video including virtual objects) presented by the internal display of the XR device.

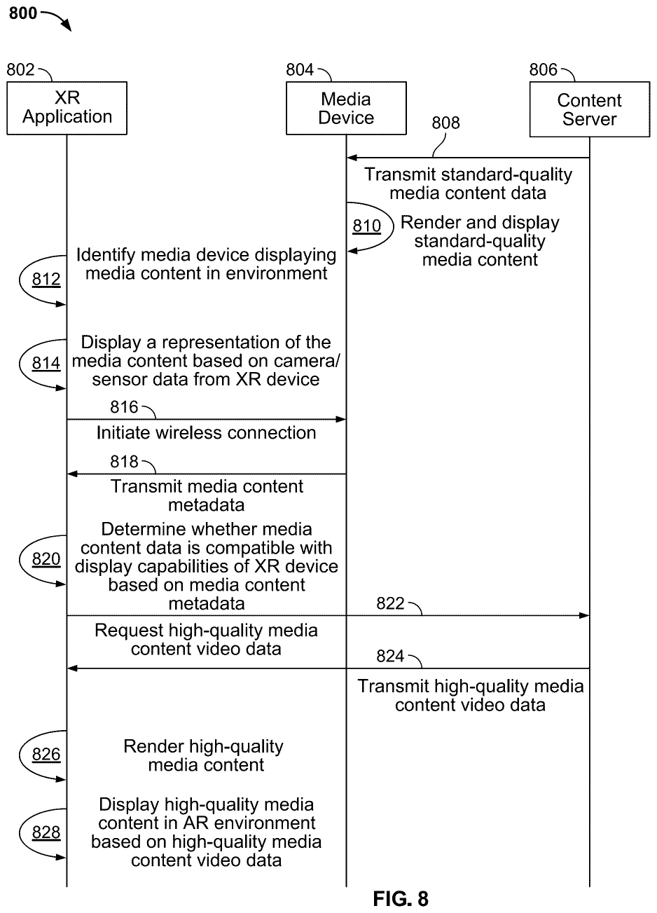

FIG. 8 is an illustrative flowchart for a process of an XR device presenting either a high-quality or a standard-quality of media content based on detection of and communication with a media device, in accordance with some embodiments of this disclosure. In some embodiments, sequence diagram 800 corresponds to the transfer of instructions that occur during streaming scenario 126 depicted in FIG. 1B. At 808, content server 806 transmits standard-quality media content data (e.g., media content data that is HDR-encoded) to media device 804. Media device 804 uses the standard-quality media content data to render and display a standard-quality of media content at 810. At 812, XR application 802 (e.g., running at least in part on control circuitry 404 of FIG. 4) identifies media device 804 displaying the media content in its surrounding environment. In some embodiments, XR application 802 uses standard wireless communication discovery protocols such as Bluetooth pairing, Wi-Fi Direct, 802.11ad, or through a local area network (LAN) or any other suitable wireless communication discovery protocol to identify the media device. At 814, when the media device enters the FOV of the XR device's cameras and/or sensors (e.g., camera 418 in FIG. 4), XR application 802 displays a representation of the media content in a pass-through video presented on the XR device's internal display, based on camera and/or sensor data.

After identifying the media device and displaying a representation of the media content, XR application 802 initiates a wireless connection (e.g., Wi-Fi, Bluetooth, etc.) between the XR device and the media device, at 816. Once the wireless connection is established, at 818 media device 804 transmits media content metadata to XR application 802. At 820 the XR application uses the received media content metadata to determine whether the media content data that media device 804 received from content server 806 is compatible with display capabilities of the XR device running XR application 802. For example, the internal display of the XR device may be HDR-enabled, and XR application 802 uses the received media content metadata to determine whether is HDR-encoded to take advantage of that display capability.

In some embodiments, XR application 802 determines that the media content displayed at media device 804 is being rendered using standard-quality media content data, e.g., content data that is not compatible with display capabilities of the XR device. In such embodiments, at 822, XR application 802 requests the high-quality media content data from content server 806, via a wireless connection (e.g., Wi-Fi). In some embodiments, XR application 702 requests media content video data from content server 806 regardless of the quality of the media content data and/or the display capabilities of the XR device. At 824, content server 806 transmits the high-quality media content data to XR application 802. At 826, XR application renders the high-quality media content based on the received content data, the XR device's display capabilities, the media content metadata, or any combination thereof, and, at 828, displays the high-quality media content in an XR environment (e.g., the pass-through video including virtual objects) presented by the internal display of the XR device.

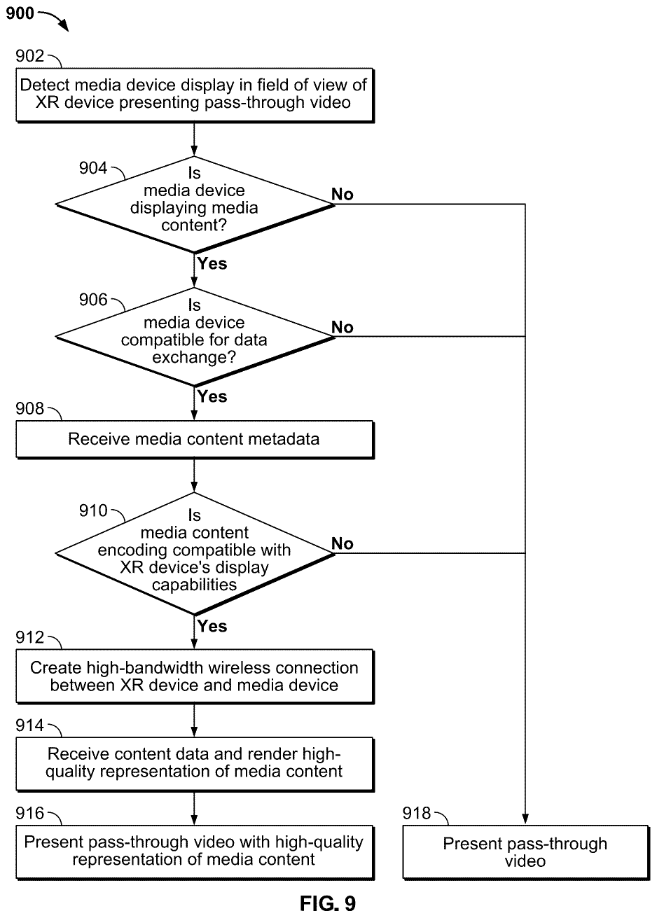

FIG. 9 is an illustrative flowchart for process 900 of an XR device presenting either a high-quality or a standard-quality of media content based on detection of and communication with a media device, in accordance with some embodiments of this disclosure. In various embodiments, the individual steps of process 900 may be implemented by one or more components of the devices and systems of FIGS. 1A-8 and 10. Although the present disclosure may describe certain steps of process 900 (and of other processes described herein) as being implemented by certain components of the devices and systems of FIGS. 1A-8 and 10, this is for purposes of illustration only, and it should be understood that other components of the devices and systems of FIGS. 1A-8 and 10 may implement those steps instead.

Process 900 begins at step 902, where control circuitry (e.g., control circuitry 404 of FIG. 4) detects the display of a media device in the FOV of an XR device presenting a pass-through video, e.g., sensors (e.g., sensors 110 of FIG. 1A-1C) of the XR device capture image/sensor data of the display in the surroundings of the XR device. Once the media device display is detected, the control determines whether the display is presenting media content at step 904. In some embodiments, the control circuitry also determines the type of display (e.g., mobile device, TV, computer monitor) that has been detected. In some embodiments, the control circuitry utilizes computer vision algorithms, sensor fusion algorithms, object recognition algorithms, or any combination thereof to detect the media device display and to determine whether it is presenting media content during steps 902, 904.

In embodiments where the control circuitry (e.g., control circuitry 404 of FIG. 4) determines that the media device display is not presenting any content, it concludes that there is no media content in the XR device's surroundings requiring identification or advanced quality rendering. In such embodiments, the control circuitry proceeds to step 918, continuing to the present pass-through video on the XR device.

In embodiments where the control circuitry (e.g., control circuitry 404 of FIG. 4) determines that the media device display is presenting media content, control circuitry proceeds to step 906. At step 906, the control circuitry determines whether the media device is compatible for an exchange of video data corresponding to the displayed media content. In some implementations, the control circuitry determines media device compatibility by requesting and receiving device information from the media device over a wireless connection (e.g., established via I/O path 402). In some embodiments, the communication protocol used to make the connection is based on Wi-Fi, Bluetooth, Miracast, or any other suitable communication protocol that facilitates smooth, real-time data transfer between devices.

If control circuitry (e.g., control circuitry 404 of FIG. 4) determines that the media device is not compatible for an exchange of video data corresponding to the displayed media content, it proceeds to step 918, continuing to the present pass-through video on the XR device. If control circuitry determines that the media device is compatible, it proceeds to step 908 where it requests and receives metadata corresponding to the presented media content via the wireless connection. The control circuitry then proceeds to step 910 where, based on the received metadata, the control circuitry determines whether the media content encoding is compatible with the XR device's display capabilities. For example, if the internal display of the XR device supports HDR content, the control circuitry determines whether the content data used for presenting the media content on the media device can be rendered in HDR. In some embodiments, control circuitry also exchanges device identification information with the device of the detected display.

If control circuitry (e.g., control circuitry 404 of FIG. 4) determines that the media content encoding is not compatible with the XR device's display capabilities (e.g., the content data is not encoded to support HDR), the control circuitry proceeds to step 918 and continues to the present pass-through video on the XR device. If control circuitry determines that the media content encoding is compatible with the XR device's display capabilities (e.g., the content data is encoded to support HDR), the control circuitry proceeds to step 912 and establishes a high-bandwidth wireless connection (e.g., Wi-Fi, Miracast, or any other suitable high-bandwidth wireless connection) between the XR device and the media device (e.g., using I/O path 402 of FIG. 4). In some embodiments, control circuitry establishes the wireless connection based on receiving a user input requesting that the connection be made. In some embodiments, the control circuitry uses Bluetooth for initial pairing with the media device via a low-bandwidth communication to exchange device information and media content metadata in steps 906, 908. If the control circuitry determines that the media device and media content coding is compatible, the control circuitry transitions to a wireless protocol (e.g., Wi-Fi) capable of high-bandwidth data transfer to facilitate the transmission of the content data.

After the wireless connection is established at step 912, the control circuitry (e.g., control circuitry 404 of FIG. 4) proceeds to step 914 to receives content data for rendering a high-quality representation of the media content at the XR device. The high-quality representation of the media content that the control circuitry renders is compatible with the display capabilities of the XR device (e.g., the control circuitry renders the representation as HDR content). In some embodiments, the control circuitry automatically establishes the wireless connection. In some embodiments, the control circuitry establishes the wireless connection after receiving a user input requesting to establish the wireless connection and to proceed with process 900. In some embodiments, the content data transfer process includes an initial handshake that involves the exchange of encryption keys, ensuring both devices are authenticated, and that connection is secure.

At step 916, the control circuitry (e.g., control circuitry 404 of FIG. 4) presents the pass-through video with the rendered high-quality representation of the media content (e.g., overlayed onto the location where the media device display is being presented within the pass-through video). In some embodiments, control circuitry performs steps 912, 914 regardless of the determination made at 910 regarding the compatibility of the media content encoding. For example, the media content encoding may only support rendering the content at a standard-quality (e.g., the content can only be rendered in SDR). In such embodiments, the control circuitry renders and presents a standard-quality representation of the media content in the pass-through video.

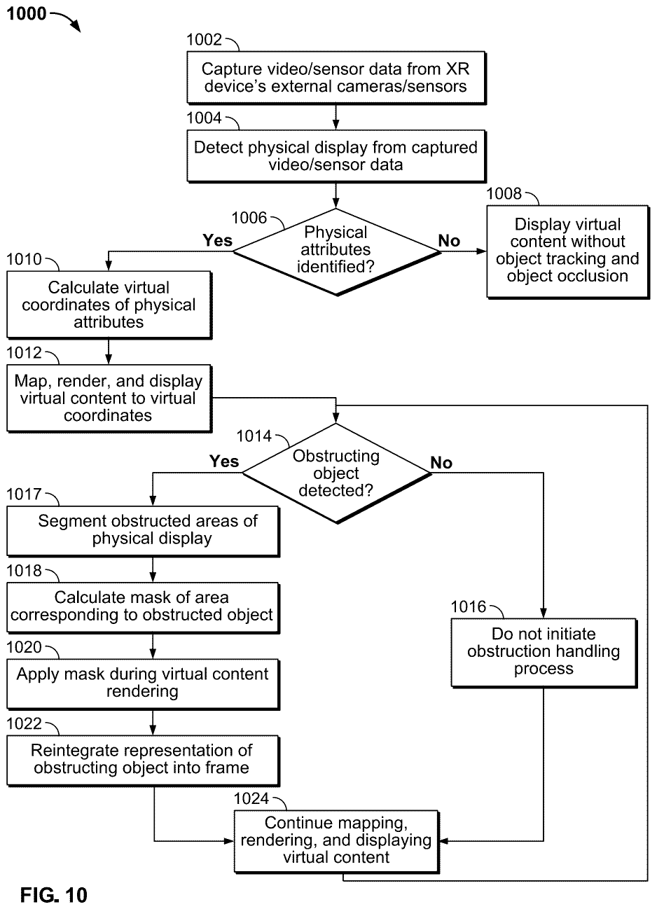

FIG. 10 is an illustrative flowchart representing a process for overlaying a virtual object onto virtual coordinates representing an external display in an environment and refraining from rendering video content portions that are occluded by a physical object in the environment, in accordance with some embodiments of this disclosure. In various embodiments, the individual steps of process 1000 may be implemented by one or more components of the devices and systems of FIGS. 1A-9. Although the present disclosure may describe certain steps of process 1000 (and of other processes described herein) as being implemented by certain components of the devices and systems of FIGS. 1A-9, this is for purposes of illustration only, and it should be understood that other components of the devices and systems of FIGS. 1A-9 may implement those steps instead.

At step 1002, the cameras and/or sensors (e.g., sensors 110 of FIGS. 1A-1C and/or camera 418 of FIG. 4) capture video/sensor data of the XR device's surroundings. At step 1004, control circuitry (e.g., control circuitry 404 of FIG. 4) detects a physical display using the captured video/sensor data. For example, the control circuitry utilizes computer vision algorithms, sensor fusion algorithms, object recognition algorithms, or any combination thereof to detect the physical display.

In some embodiments, the aforementioned algorithms are used to generate a spatial map of the surroundings of the XR device's surroundings. At step 1006, control circuitry (e.g., control circuitry 404 of FIG. 4) attempts to identify physical attributes (e.g., corners, edges, etc.) of the detected physical display. For example, in some embodiments, the control circuitry utilizes spatial mapping to identify physical attributes of the display, such as borders and corners, and assigns spatial coordinates to these attributes. These coordinates are then used to track and integrate virtual media content into an XR environment that blends virtual objects with pass-through video. In some embodiments, the virtual media content that is integrated into the XR environment corresponds to media content that was identified and requested from a media device in the XR device's surroundings in accordance with process 900 of FIG. 9.

If no physical attributes of the detected physical display can be identified at step 1006, control circuitry (e.g., control circuitry 404 of FIG. 4) proceeds to step 1008 and displays virtual content within the XR environment without object tracking and object occlusion. For example, instead of tracking virtual content to the physical attributes of the display, the control circuitry may, in some embodiments, track the virtual content to another surface suitable for displaying the virtual object within the XR environment, such as an empty wall space. This suitable surface may be identified either based on user input or automatically using a computer vision algorithm. For example, a user may hold up their hands to indicate a box in their FOV—e.g., around the physical display or around an empty wall space within the physical environment. In such embodiments, it enables the user to reposition and/or resize the high-quality content within the XR environment. In such embodiments, all other steps of process 1000 are still performed.

If the control circuitry (e.g., control circuitry 404 of FIG. 4) identifies physical attributes (e.g., corners) of a physical display, the control circuitry proceeds to step 1010 where it calculates the virtual coordinates of the physical attributes of the physical display. As described above, in some embodiments the control circuitry utilizes a spatial mapping of the XR device's surroundings to determine the virtual coordinates of the identified physical attributes. In some embodiments, the calculated virtual coordinates are used in computing a homography matrix, which defines the transformation between the detected quadrilateral shape of the display (as seen by the user) and the ideal rectangular coordinate system. In such embodiments, the homography matrix allows the system to accurately project the HDR content onto the display, regardless of the user's angle.

At step 1012, control circuitry (e.g., control circuitry 404 of FIG. 4) maps, renders, and displays virtual content onto the calculated virtual coordinates of the XR environment (e.g., using the homography matrix). By displaying the virtual content at the virtual coordinates, the control circuitry creates the illusion that the virtual content is being presented by the physical display rather than being a virtual component of the XR environment.

At step 1014, control circuitry (e.g., control circuitry 404 of FIG. 4) monitors for obstructing objects between the XR device and the physical display that prevent the sensors (e.g., sensors 110 of FIGS. 1A-1C and/or camera 418 of FIG. 4) of the XR device from capturing every portion of the physical display. If no obstructing objects are detected, the control circuitry proceeds to step 1016 and 1024, where it continues rendering and displaying the virtual content without any initiating the obstruction handling process.

If the control circuitry (e.g., control circuitry 404 of FIG. 4) detects obstructing objects between the XR device and the physical display, the control circuitry proceeds to step 1017. At step 1017 the control circuitry utilizes semantic segmentation algorithm(s) to segment the obstructed areas of the physical display and/or other objects of the physical environment (e.g., control circuitry generates segmentations 307, 308, 309 of FIG. 3).

At step 1018, the control circuitry (e.g., control circuitry 404 of FIG. 4) calculates a mask (e.g., mask 310 of FIG. 3) for displaying virtual objects in the XR environment, with the excluded portions of the mask (e.g., exclusion region 312) corresponding to areas of the physical display obstructed by an object(s) in the physical environment. At step 1020, the control circuitry (e.g., control circuitry 404 of FIG. 4) applies the mask during the rendering of the virtual content. When the virtual content is rendered with the applied mask, portions of the content corresponding to the obstruction are left blank, thereby ensuring that the virtual object is not rendered over any part of the obstructing object.

At step 1022, the control circuitry (e.g., control circuitry 404 of FIG. 4) reintegrates a representation of the obstructing object into the frame of the virtual content, making it appear as though the obstructing object is positioned in front of the virtual content within the XR environment. The control circuitry (e.g., control circuitry 404 of FIG. 4) then proceeds to step 1024 where it continues rendering and displaying the virtual content with the accounted for obstruction. For example, this step may include continuously updated the homography matrix and rendering pipeline based on the user's movement. The control circuitry continuously monitors for new obstructions between the XR device and the physical display. If a new obstruction is detected, it re-executes steps 1017 through 1022.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A computer-implemented method, comprising:
identifying, by an extended reality (XR) device, a media device located in a physical environment of the XR device, wherein the media device displays media content, and wherein the XR device displays a pass-through video of the physical environment including a representation, captured by a camera of the XR device, of the media device displaying the media content, and wherein the display of the representation of the media content is defined, at least in part, by at least one display parameter having at least one first value;
initiating a wireless connection between the XR device and the media device;
receiving, at the XR device and via the wireless connection, data associated with the media content being displayed at the media device;
determining a capability of a display of the XR device in relation to the at least one display parameter;
based at least in part on the determined capability and the data received via the wireless connection, processing the representation of the media content to cause the representation of the media content to be characterized at least in part by the at least one display parameter having at least one second value instead of the at least one first value; and
displaying the processed representation of the media content at the XR device.

2. The method of claim 1, wherein the at least one display parameter is dynamic range, and wherein the at least one first value corresponds to standard dynamic range (SDR) video, and the at least one second value corresponds to high dynamic range (HDR) video.

3. The method of claim 1, wherein processing the representation of the media content includes performing tone mapping on the representation of the media content, where performing the tone mapping comprises:
modifying a brightness value and a contrast value of the representation of the media content based at least in part on a luminance capability of the XR device.

4. The method of claim 1, wherein processing the representation of the media content is further based at least in part on determining that a capability of the camera of the XR device is insufficient to enable the display of the representation of the media content, as captured by the camera, to be defined at least in part by the at least one display parameter having the at least one second value.

5. The method of claim 1, wherein the display of the media content at the media device is defined at least in part by the at least one display parameter having the at least one second value, and wherein the processing further comprises adapting the display of the representation of the media content defined at least in part by the at least one display parameter having the at least one first value to the display of the media content defined at least in part by the at least one display parameter having the at least one second value.

6. The method of claim 1, wherein the data received via the wireless connection comprises the media content being displayed at the media device, and metadata indicating one or more display parameters of the media content being displayed at the media device.

7. The method of claim 1, wherein the identifying, by the XR device, the media device located in the physical environment comprises:
determining that the media device is in a field of view (FOV) of the XR device; and
identifying one or more physical characteristics of the media device, wherein the one or more physical characteristics comprise at least one of display edges of the media device; and
based at least in part on the one or more identified physical characteristics of the media device, calculating virtual coordinates corresponding to the display of the media device within a mixed reality or augmented reality environment and displaying the processed representation at the calculated virtual coordinates.

8. The method of claim 7, wherein the one or more physical characteristics are determined using computer vision, and the one or more physical characteristics further comprises at least one of dimensions of the media device, corners of the media device, or an orientation of the media device.

9. The method of claim 7, wherein the displaying the processed representation of the media content at the XR device comprises:
displaying the processed representation of the media content at the calculated virtual coordinates corresponding to the display of the media device within the mixed reality or augmented reality environment;
determining, based on tracking the XR device, that the XR device has been moved to a new position within the physical environment and that the FOV has changed; and
after determining that the XR device has moved to the new position and that the FOV has changed, continuing to display the processed representation of the media content at the calculated virtual coordinates corresponding to the display of the media device within the mixed reality or augmented reality environment.

10. (canceled)

11. The method of claim 7, wherein the displaying the processed representation of the media content at the XR device further comprises:
determining that an object in the physical environment is located between the display of the media device and the XR device;
creating a mask of the object within the mixed reality or augmented reality environment; and
refraining from displaying portions of the processed representation of the media content covered by the mask of the object within the mixed reality or augmented reality environment.

12-13. (canceled)

14. A system, comprising:
control circuitry configured to:
identify, by an extended reality (XR) device, a media device located in a physical environment of the XR device, wherein the media device displays media content, and wherein the XR device displays a pass-through video of the physical environment including a representation, captured by a camera of the XR device, of the media device displaying the media content, and wherein the display of the representation of the media content is defined, at least in part, by at least one display parameter having at least one first value; and
input/output circuitry configured to:
initiate a wireless connection between the XR device and the media device; and
wherein the control circuitry is further configured to:
receive, at the XR device and via the wireless connection, data associated with the media content being displayed at the media device;
determine a capability of a display of the XR device in relation to the at least one display parameter;
based at least in part on the determined capability and the data received via the wireless connection, process the representation of the media content to cause the representation of the media content to be characterized at least in part by the at least one display parameter having at least one second value instead of the at least one first value; and
wherein the input/output circuitry is further configured to:
display the processed representation of the media content at the XR device.

15. The system of claim 14, wherein the at least one display parameter is dynamic range, and wherein the at least one first value corresponds to standard dynamic range (SDR) video, and the at least one second value corresponds to high dynamic range (HDR) video.

16. The system of claim 14, wherein the control circuitry configured to process the representation of the media content is further configured to perform tone mapping on the representation of the media content, and wherein the control circuitry performs the tone mapping by:
modifying a brightness value and a contrast value of the representation of the media content based at least in part on a luminance capability of the XR device.

17. The system of claim 14, wherein the control circuitry is further configured to process the representation of the media content based at least in part on determining that a capability of the camera of the XR device is insufficient to enable the display of the representation of the media content, as captured by the camera, to be defined at least in part by the at least one display parameter having the at least one second value.

18. The system of claim 14, wherein the display of the media content at the media device is defined at least in part by the at least one display parameter having the at least one second value, and wherein the control circuitry is further configured to adapt the display of the representation of the media content defined at least in part by the at least one display parameter having the at least one first value to the display of the media content defined at least in part by the at least one display parameter having the at least one second value.

19. The system of claim 14, wherein the data received via the wireless connection comprises the media content being displayed at the media device, and metadata indicating one or more display parameters of the media content being displayed at the media device.

20. The system of claim 14, wherein the control circuitry identifies, by the XR device, the media device located in the physical environment by:
determining that the media device is in a field of view (FOV) of the XR device; and
identifying one or more physical characteristics of the media device, wherein the one or more physical characteristics comprise at least one of display edges of the media device; and
based at least in part on the one or more identified physical characteristics of the media device, calculating virtual coordinates corresponding to the display of the media device within a mixed reality or augmented reality environment and displaying the processed representation at the calculated virtual coordinates.

21. The system of claim 20, wherein the one or more physical characteristics are determined using computer vision, and the one or more physical characteristics further comprises at least one of dimensions of the media device, corners of the media device, or an orientation of the media device.

22. The system of claim 20, wherein the input/output circuitry is configured to display the processed representation of the media content at the XR device by:
displaying the processed representation of the media content at the calculated virtual coordinates corresponding to the display of the media device within the mixed reality or augmented reality environment; and
wherein, to display the processed representation of the media content at the XR device, the control circuitry is further configured to:
determine, based on tracking the XR device, that the XR device has been moved to a new position within the physical environment and that the FOV has changed; and
wherein the input/output circuitry is further configured to:
after determining, by the control circuitry, that the XR device has moved to the new position and that the FOV has changed, continue to display the processed representation of the media content at the calculated virtual coordinates corresponding to the display of the media device within the mixed reality or augmented reality environment.

23. (canceled)

24. The system of claim 20, wherein, to display the processed representation of the media content at the XR device, the control circuitry is further configured to:
determine that an object in the physical environment is located between the display of the media device and the XR device;
create a mask of the object within the mixed reality or augmented reality environment; and
refrain from displaying portions of the processed representation of the media content covered by the mask of the object within the mixed reality or augmented reality environment.

25-65. (canceled)
